(19) United States
(12) Patent Application Publication
(10) Pub. No.: US 2024/0362039 A1
(43) Pub. Date: Oct. 31, 2024

(54) PROGRAM CONTROL METHOD AND APPARATUS, ELECTRONIC DEVICE, AND MEDIUM

(71) Applicant: VIVO MOBILE COMMUNICATION CO., LTD., Dongguan (CN)

(72) Inventor: Xiangxiang Li, Dongguan (CN)

(73) Assignee: VIVO MOBILE COMMUNICATION CO., LTD., Dongguan (CN)

(21) Appl. No.: 18/764,357

(22) Filed: Jul. 4, 2024

Related U.S. Application Data
(63) Continuation of application No. PCT/CN2023/070031, filed on Jan. 3, 2023.

(30) Foreign Application Priority Data
Jan. 6, 2022 (CN) 202210014117.X

(51) Int. Cl. G06F 9/451; G06F 3/04817; G06F 3/0484; G06F 9/54

(52) U.S. Cl. CPC G06F 9/451; G06F 3/0484; G06F 9/54; G06F 3/04817

(57) ABSTRACT

A program control method, an electronic device, and a non-transitory computer-readable storage medium are provided. The method includes: displaying a first identifier and a second identifier in a target control. The first identifier is used to indicate a first program and the second identifier is used to indicate a second program. The method further includes starting a first function when first information meets a first preset condition. The first information is information from the first program, and the first function is a function of the second program.

### CROSS-REFERENCE TO RELATED APPLICATIONS

This application is a continuation of International Application No. PCT/CN2023/070031, filed on Jan. 3, 2023, which claims priority to Chinese Patent Application No. 202210014117.X, filed on Jan. 6, 2022. The entire contents of each of the above-referenced applications are expressly incorporated herein by reference.

### TECHNICAL FIELD

This application relates to the field of communication technologies, and specifically, to a program control method and apparatus, an electronic device, and a medium.

### BACKGROUND

With the development of mobile Internet, various applications serve different business scenarios, meeting online needs of users in their daily lives. As application vendors focus on their own business field, users may have to switch back and forth between different applications when processing a certain transaction, resulting in users having to go through a series of cumbersome operations to complete the processing, which affects operating experience of the users.

For example, in the context of shipping a package for express delivery, after a user places an order on an application, a courier will come to pick up the package, and the courier will contact the user in advance before picking up the package. The user answers a call from the courier through a phone application and uses an access control application to open the door for the courier. In this process, the user needs to operate multiple applications to ship the package for express delivery, which is inconvenient.

It can be seen that in the prior art, when a user carries out an online activity, the user needs to switch back and forth between different applications to complete transaction processing through a series of cumbersome operations.

### SUMMARY

Embodiments of this application are intended to provide a program control method and apparatus, an electronic device, and a medium.

According to a first aspect, an embodiment of this application provides a program control method, including:
displaying a first identifier and a second identifier in a target control, the first identifier being used to indicate a first program and the second identifier being used to indicate a second program; and
starting a first function in a case that first information meets a first preset condition; where
the first information is information from the first program, and the first function is a function of the second program.

According to a second aspect, an embodiment of this application provides a program control apparatus including:
a first display module configured to display a first identifier and a second identifier in a target control, the first identifier being used to indicate a first program and the second identifier being used to indicate a second program; and
a first starting module configured to start a first function in a case that first information meets a first preset condition; where
the first information is information from the first program, and the first function is a function of the second program.

According to a third aspect, an embodiment of this application provides an electronic device, where the electronic device includes a processor and a memory. The memory stores a program or instructions capable of running on the processor. When the program or instructions are executed by the processor, the steps of the method according to the first aspect are implemented.

According to a fourth aspect, an embodiment of this application provides a readable storage medium, where the readable storage medium has a program or instructions stored thereon, and when the program or the instructions are executed by a processor, the steps of the method according to the first aspect are implemented.

According to a fifth aspect, an embodiment of this application provides a chip, where the chip includes a processor and a communication interface, the communication interface is coupled to the processor, and the processor is configured to run a program or instructions so as to implement the method according to the first aspect.

According to a sixth aspect, an embodiment of this application provides a computer program product, where the program product is stored in a storage medium, and the program product is executed by at least one processor to implement the method according to the first aspect.

In the embodiments of this application, by displaying the first identifier indicating the first program and the second identifier indicating the second program in the target control, and starting the first function of the second program in a case that the first information from the first program meets the first preset condition, it is possible to implement an association between the first program and the second program based on the target control, trigger the starting of the first function based on the state of the first program, and implement the sharing of the first function. This improves the interaction ability between programs, enriches the capability of information sharing and intercommunication between programs, ensures that the users can effectively cascade programs, reduces the participation frequency of the user in transaction processing, improves the efficiency of the transaction processing, and optimizes experience of the user in transaction processing.

### BRIEF DESCRIPTION OF DRAWINGS

FIG. 1 is a flowchart of a program control method according to an embodiment of this application;

FIG. 2 is a schematic diagram of establishing a program association relationship based on a drag input according to an embodiment of this application;

FIG. 3 is a schematic diagram of selecting among a plurality of functions of a second program according to an embodiment of this application;

FIG. 4 is a schematic diagram of selecting a program and establishing an association between an access control program and the selected program according to an embodiment of this application;

FIG. 5 is a schematic diagram of displaying prompt information on whether to start a door opening function on an order screen according to an embodiment of this application;

FIG. 6 is a schematic diagram of the order screen, showing that a door opening function is enabled and prompting a user to click according to an embodiment of this application;

FIG. 7 is a schematic diagram of synchronizing a function starting record to Notepad according to an embodiment of this application;

FIG. 8 is a schematic diagram of displaying prompt information on whether to use a communication function on an order screen according to an embodiment of this application;

FIG. 9 is a schematic diagram of synchronizing a pickup notification to a communication program according to an embodiment of this application;

FIG. 10 is a schematic diagram of a program control apparatus according to an embodiment of this application;

FIG. 11 is a first schematic block diagram of an electronic device according to an embodiment of this application; and

FIG. 12 is a second schematic block diagram of an electronic device according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

The terms “first”, “second”, and the like in this specification and claims of this application are used to distinguish between similar objects rather than to describe a specific order or sequence. It should be understood that data used in this way is used interchangeably in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, “and/or” in the specification and claims represents at least one of connected objects, and the character “/” generally indicates that the associated objects have an “or” relationship.

The following describes in detail a program control method provided in the embodiments of this application through embodiments and application scenarios thereof with reference to the accompanying drawings.

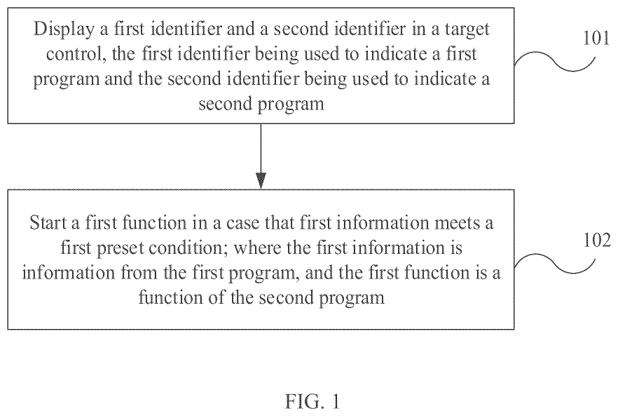

Referring to FIG. 1, an embodiment of this application provides a program control method including the following steps.

Step 101. Display a first identifier and a second identifier in a target control, the first identifier being used to indicate a first program and the second identifier being used to indicate a second program.

The program control method provided in this embodiment of this application can establish, based on a target control, an association relationship between a first program and a second program that are installed in an electronic device, so as to implement function sharing between the programs.

Based on an input by a user, the electronic device controls the first identifier corresponding to the first program and the second identifier corresponding to the second program to be displayed in the target control to establish the association between the two programs through the target control. The target control can be displayed in a graphical user interface of the electronic device based on a trigger condition, and the target control can be controlled to hide when not in use. In case of displaying the target control, an association relationship between the first program and the second program for cooperatively processing a target transaction can be established based on the target control, and based on the association relationship, function sharing and further data sharing can be implemented.

In this embodiment of this application, the first program and the second program cooperate to process the target transaction. For example, the second program and the first program cooperate to process an express package pickup transaction. The first program is a program that supports functions of express package pickup and delivery, and based on the first program, the user can know an express package delivery status. The second program is a program that can control access to a door, and the user opens the door for a courier based on the second program. Through the cooperation between the first program and the second program, the user can complete an express package pickup transaction. In some alternative embodiments, the second program and the first program cooperate with each other to know shopping details. The first program is an e-commerce program, and the user purchases goods based on the first program. The second program is a communication program and can send information about the shopping details corresponding to the first program to a contact in the communication program, so that the second program can know the shopping details through a communication record with the contact.

Step 102: Start a first function in a case that first information meets a first preset condition; where the first information is information from the first program, and the first function is a function of the second program.

The display of the first identifier and the second identifier in the target control indicates that an association between the first program and the second program has been established. In the process of the first program processing the target transaction, the electronic device monitors the state of the first program in real time. The electronic device automatically starts the first function of the second program in a case that the first information from the first program meets the first preset condition, so that the first program can continue to process the target transaction based on the first function started, and the first function of the second program can be shared to the first program, so as to ensure smooth execution of the target transaction based on the function sharing. The first preset condition is a condition required for starting the first function.

For example, the electronic device knows an express package delivery status based on the program that supports functions of express package pickup and delivery. When detecting that a courier arrives at a unit door, the electronic device determines that a state corresponding to the program that supports the functions of express package pickup and delivery meets the first preset condition. In this case, the electronic device triggers an access control program to start the door opening function, so that the courier can enter the corresponding floor to deliver the express package.

In the foregoing implementation process of this application, by displaying the first identifier indicating the first program and the second identifier indicating the second program in the target control, and starting the first function of the second program in a case that the first information from the first program meets the first preset condition, it is possible to implement an association between the first program and the second program based on the target control, trigger the starting of the first function based on the state of the first information, and implement the sharing of the first function. This improves the interaction ability between programs, enriches the capability of information sharing and intercommunication between programs, ensures that the users can effectively cascade programs, reduces the participation frequency of the user in transaction processing, and improves the efficiency of transaction processing.

In some embodiments, when starting the first function, step 102 includes at least one of the following schemes: granting permission to the target control or the first program to call the first function; and controlling the second program to start the first function.

In starting the first function of the second program, permission can be granted to the target control, so that the target control has permission to call the first function, and the first function can be started through the target control calling the first function, so as to implement triggering of the target control to call the first function based on the first information from the first program. In some alternative embodiments, in starting the first function of the second program, permission can be granted to the first program, so that the first program has permission to call the first function, and the first function can be started through the first program calling the first function, so as to implement triggering of the first program to call the first function based on the first information from the first program.

In starting the first function of the second program, the second program can be directly controlled to start the first function, so as to implement triggering of the second program to directly start the first function based on the first information from the first program.

In some alternative embodiments, in starting the first function of the second program, permission can be granted to the target control, so that the target control has permission to call the first function and controls the second program to directly start the first function, so as to implement starting of the first function through both the target control and the second program. Accordingly, permission can be granted to the first program, so that the first program has permission to call the first function and controls the second program to directly start the first function, so as to implement starting of the first function in two ways: through the first program and the second program.

In the foregoing implementation process, by granting permission to the target control or the first program to start the first function, it is possible to start the first function in the indirect calling mode; and by controlling the second program to start the first function, it is possible to start the first function in direct control mode. In some alternative embodiments, by granting permission to the target control and controlling the second program to start the first function, or by granting permission to the first program and controlling the second program to start the first function, it is possible to start the first function in two ways, so that when the first function is not started successfully in a way, the first function can be started in a second way.

The following describes in detail the case of granting permission to the target control or the first program to call the first function in the foregoing embodiment.

In a case that permission is granted to the first program to call the first function of the second program, the calling of the first function of the second program can be implemented based on the first program. For example, the first function can be started according to a function starting input by the user for the first program, so as to implement the starting of the first function based on the call status of the first function and through the first program. In this implementation, the first function of the second program can be started through the first program with the participation of the user, and as compared with a case of switching programs to start the first function in the prior art, the operation flow can be simplified.

In a case that permission is granted to the target control to call the first function of the second program, the first function can be bound to the target control, the target control can call the first function depending on triggering of the target control by the user. In this case, the first function can be started without program switching.

By granting permission to the target control or the first program to call the first function, the target control or the first program can call the first function, thereby ensuring the processing efficiency of the target transaction and avoiding switching between programs.

After granting permission to the target control or the first program to call the first function, the method further includes: prohibiting the target control or the first program from calling the first function in a case that the first information meets a second preset condition.

Subsequent to granting permission to the target control or the first program to call the first function based on the first information that meets the first preset condition, the first function can be started through the target control or the first program, so that the first program can continue to process the target transaction based on the first function. After the first program processes the target transaction, the first information from the first program meets the second preset condition, and in this case, the target control or the first program can be prohibited from calling the first function, so as to stop the sharing of the first function in a timely manner and ensure the rigor of calling the first function. The second preset condition is a condition under which the first function does not need to be used and can also be understood as the condition under which the sharing of the first function is stopped.

For example, the second program and the first program cooperate to process an express package pickup transaction. The first program is a program that supports functions of express package pickup and delivery, and based on the first program, the user can know an express package delivery status. The second program is a program that can control access to a door. When a courier arrives at a unit door, the electronic device grants permission to the first program to call the door opening function of the second program so that the courier can enter the unit door and prohibits the first program from calling the first function after the courier enters the unit door or the courier completes the express package delivery and leaves the unit door.

In the foregoing implementation process, in a case that permission is granted to the target control or the first program to call the first function, when it is detected that the first information from the first program meets the second preset condition, the target control or the first program is prohibited from calling the first function. In this way, based on the first information that meets the second preset condition, the calling of the first function can be prohibited, and the sharing of the first function can be stopped in a timely manner, ensuring the rigor of calling the first function.

In some embodiments, before the displaying a first identifier and a second identifier in a target control, the method further includes: receiving a first input by a user in a case that the target control, a first application icon, and a second application icon are displayed, the first application icon being an icon of the first program and the second application icon being an icon of the second program; and the displaying a first identifier and a second identifier in a target control includes: displaying the first identifier and the second identifier in the target control in response to the first input.

In this embodiment, the association between the first program and the second program can be established based on the target control in a case that the target control is displayed, so that the first program shares the first function of the second program. The following illustrates the process of establishing the association between the first program and the second program based on the target control.

Based on user input, the target control is triggered to display in the graphical user interface of the electronic device. In a case that the target control, the first application icon corresponding to the first program, and the second icon corresponding to the second program are displayed in the graphical user interface of the electronic device, the first input by the user is received. The first input may be an input for the first application icon, the second application icon, and the target control, or may be an input associating the first application icon and the second application icon with the target control.

In response to the first input by the user, the association between the first program and the second program is established based on the target control, and the first identifier corresponding to the first program and the second identifier corresponding to the second program are displayed in the target control. The first identifier may be the first application icon, and the second identifier may be the second application icon. The first identifier may be an identifier determined based on the first application icon, for example, through reducing the first application icon by a preset ratio, and correspondingly, the second identifier can also be an identifier determined based on the second application icon.

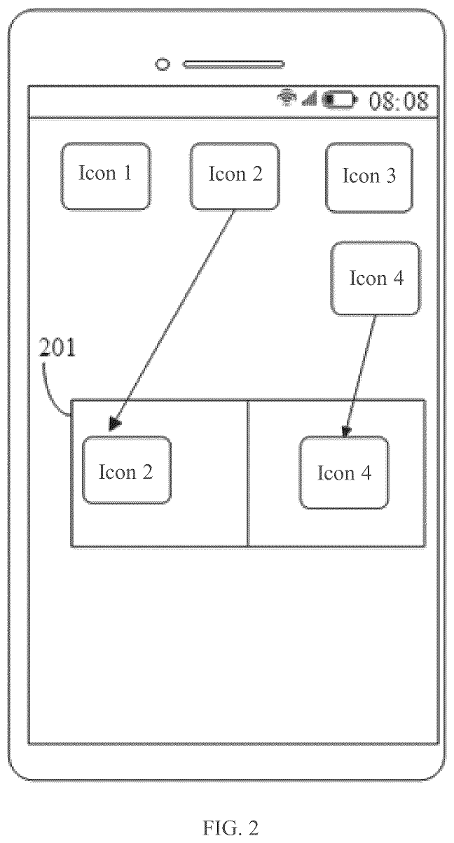

The following illustrates the foregoing process through an example. As shown in FIG. 2, a target control 201 is displayed in a graphical user interface of an electronic device, and a drag input for an icon (icon 4) corresponding to a first program (program 4) and an drag input for an icon (icon 2) corresponding to a second program (program 2) by a user are received, so that the icon corresponding to the first program is dragged to a first region of the target control 201, and the icon corresponding to the second program is dragged to a second region of the target control 201, implementing function sharing between the first program and the second program through the target control 201. The first region is a region corresponding to the program using the function, and the second region is a region corresponding to the program providing the function.

After the first application icon is dragged to the first region of the target control and the second application icon is dragged to the second region of the target control, the first identifier (first application icon) and the second identifier (second application icon) are displayed in the target control.

In the foregoing implementation process, the first input by a user is received in the case that the target control, the first application icon, and the second application icon are displayed, and the first identifier and the second identifier are displayed in the target control in response to the first input. The association between the first program and the second program can be established depending on the triggering by the user, and by controlling the display of the first and second identifiers in the target control, the user can more easily know a state of the association between the first program and second program.

In some embodiments, during establishing the association between the first program and the second program, N functions between the first program and the second program can be shared, where the N functions are at least some of a plurality of functions corresponding to the second program, the N functions include the first function, N is an integer greater than or equal to 1, and the N functions may be pre-selected.

In a case that the N functions are all of a plurality of functions corresponding to the second program, the plurality of functions of the second program can all be shared. In a case that the N functions are some of a plurality of functions corresponding to the second program, some of the plurality of functions of the second program can be shared.

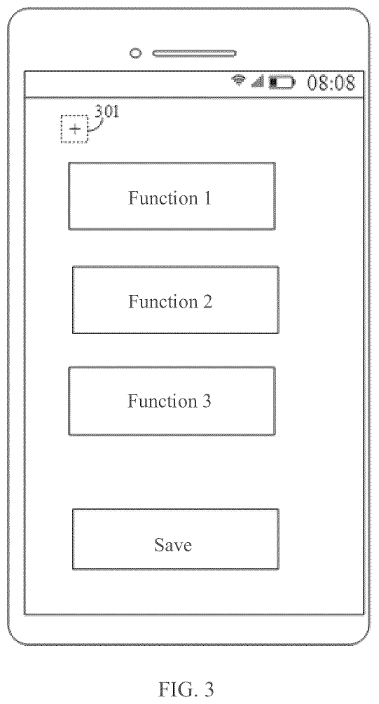

Since the N functions are pre-selected, a plurality of functions corresponding to the second program can be displayed on a settings screen associated with the second program to filter out the N functions. The following describes a case of filtering out N functions through an example. Upon receiving an input by the user, that meets a preset input characteristic, for the second program, a plurality of functions corresponding to the second program are displayed on the settings screen associated with the second program. For example, as shown in FIG. 3, after the settings screen associated with the second program is displayed, based on an input by the user for a function display control 301 (a plus sign in FIG. 3) on the settings screen, three functions corresponding to the second program are displayed: function 1, function 2, and function 3. Function 1 and function 2 are selected based on a selection by the user in the three functions, and the selected function 1 and function 2 are implemented based on an input by the user for a save control.

In the foregoing implementation process, by selecting N functions from a plurality of functions corresponding to the second program, it is possible to share the N functions in a case that the association between the second program and the first program has been established.

In an embodiment of this application, at least one third identifier is further displayed in the target control, the third identifier being used to indicate a third program. The method further includes: receiving a second input by a user for a first target identifier in the at least one third identifier, the first target identifier being used to indicate a first target program; and in response to the second input, starting the first function in a case that second information meets the first preset condition; where the second information is information from the first target program.

In addition to the first identifier and the second identifier, at least one third identifier may further be displayed in the target control, where the third identifier is used to indicate a third program, and the third program is in common with the first program in that both programs are associated with the second program. Based on the association with the second program, a relationship of sharing N functions between the third program and the second program can be established.

In a case that there are a plurality of third programs, during establishing associations between the second program and the plurality of third programs, the associations between the second program and the plurality of third programs can be established at a time to implement the sharing of N functions. In this case, the N functions corresponding to the plurality of third programs are the same, and the N functions include the first function. In some alternative embodiments, the associations between the second program and at least some of the N functions of the plurality of third programs can be established sequentially according to priorities of the plurality of third programs (a value of N is greater than 1). In this case, the number and/or content of the functions corresponding to the plurality of third programs are different, and an association is formed between each third program and the first function of the second program.

The priorities of the plurality of third programs can be determined based on the program importance level, program usage duration, and program usage frequency. For example, a higher priority is assigned to a program with a higher importance level, a higher priority is assigned to a program with a longer usage duration, and a higher priority is assigned to a program with a higher usage frequency. In some alternative embodiments, the priorities can be set by the user. Of course, the way of determining priorities is not limited thereto. After the priorities of the plurality of third programs are determined, the associations with the second program can be established sequentially for the plurality of third programs based on a descending order of priorities. Each third program can be associated with at least some of the N functions of the second program (that is, forming a function sharing relationship), the number of functions corresponding to each third program may or may not be the same, and when the number of functions is the same, the contents of the functions may be different. In this implementation, a plurality of third programs can establish the association with the second program one by one.

In a case that the value of N is greater than 1, during establishing the associations between the second program and a plurality of third programs, the N functions of the second program can be sorted to determine priorities of the N functions. The priorities of the N functions can be determined based on the function usage frequency, function importance level, and latest function usage time. For example, a higher priority is assigned to a function with a higher usage frequency, a higher priority is assigned to a function with a higher importance level, and a higher priority is assigned to a function with a latest usage time closest to a current time. In some alternative embodiments, the priorities can be set by the user. Of course, the way of determining priorities is not limited thereto. After the priorities of the N functions are determined, the association relationships between the second program and at least some of the third programs can be established sequentially for the N functions in a descending order of priorities. Each of the N functions may correspond to the same or different number of third programs, and accordingly, each of the N functions may correspond to the same or different third programs. For a first function of the N functions, the association between the second program and each third program can be established based on this function.

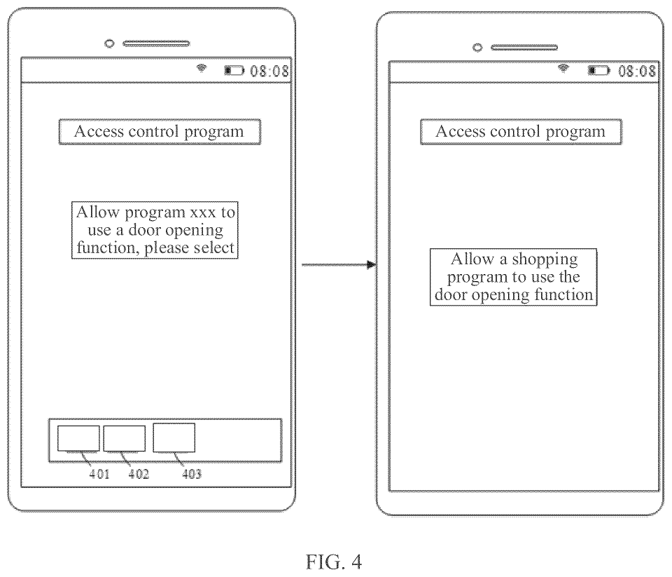

In this embodiment of this application, the associations between the second program and the third program can be established one by one for the N functions. For example, as shown in FIG. 4, during synchronizing a door opening function of an access control program, the user may select from a plurality of icons (takeaway icon 401 for a takeaway program, shopping icon 402 for a shopping program, and an express delivery icon 403 for an express delivery program) corresponding to a plurality of third programs. In a case that the user selects the shopping icon 402, the shopping program can be allowed to use the door opening function, and the association between the access control program and the shopping program can be established based on the door opening function, so as to implement the sharing of the door opening function.

In establishing association relationships between the second program and a plurality of third programs according to the priorities of the plurality of third programs or the priorities of N functions, it is possible to ensure orderliness in establishing the association relationships while implementing rapid establishment of the associations between the second program and the plurality of third programs.

In case of establishing the association between at least one third program and the second program, the target control can display at least one third identifier, the third identifier being of a same category as a first identifier. Upon receiving a second input by a user for a first target identifier in the at least one third identifier, it is determined that a trigger condition for inspecting second information is detected. The second input by the user for the first target identifier can be understood as a selection input in at least one third identifier, and a third identifier selected by the user is the first target identifier.

The second information from the first target program corresponding to the first target identifier is inspected in response to the second input by the user for the first target identifier, and a first function is started when the second information from the first target program meets the first preset condition. In this way, it is possible to select the first target identifier based on the second input by the user, then trigger the inspection of the second information from the first target program corresponding to the first target identifier, and start the first function when the second information meets the first preset condition for starting the first function of the second program.

In the process of starting the first function, permission can be granted to a target control or the first target program, so that the target control or the first target program has permission to call the first function, and the first function can be started by calling the first function through the target control or the first target program. In the process of starting the first function, the second program can be directly controlled to start the first function. In some alternative embodiments, in starting the first function, the target control or the first target program can be granted permission to control the second program to directly start the first function. For the detailed process of starting the first function, reference can be made to the embodiment of starting the first function, and details are not repeated herein.

In the foregoing implementation process of this application, by establishing the association between the second program and at least one third program, displaying at least one third identifier in the target control, inspecting the second information corresponding to the first target program according to the second input by the user for the first target identifier in the at least one third identifier, and starting the first function in a case that the second information meets the first preset condition, it is possible to start the first function based on the trigger from the user and the second information, ensuring that the first target program can call the first function.

In an embodiment of this application, in a case that the first identifier and the second identifier are displayed in the target control, before starting a first function, the method further includes: displaying prompt information for the first function in a program screen of the first program. The starting a first function in a case that first information meets a first preset condition includes: starting the first function in a case that a confirmation input by the user for the prompt information has been received and that the first information meets the first preset condition.

In this embodiment, the first program is associated with the second program, and a function sharing relationship is formed between the first program and the second program, so that the first function of the second program can be utilized when the target transaction is processed based on the first program. Since the first program corresponds to the first identifier and the second program corresponds to the second identifier, the first identifier and the second identifier can be displayed in the target control.

In a case that the first identifier and the second identifier are displayed in the target control, prompt information can be displayed on a program screen of the first program corresponding to the first identifier, the prompt information being used to prompt the user to start the first function. In a case that the confirmation input by the user for the prompt information displayed on the program screen of the first program has been received, the first information from the first program is inspected. When the first information meets the first preset condition, the first function of the second program is started. In this case, it can be determined based on the confirmation input by the user that the first function needs to be started, so as to start the first function when the first information that meets the first preset condition is detected.

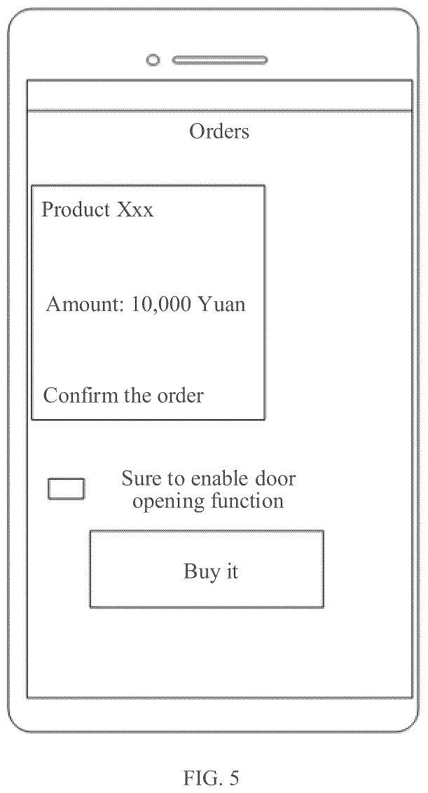

The following illustrates the foregoing process using two examples. As shown in FIG. 5, a first program is a shopping program; prompt information on whether to enable a first function of a second program (for example, a door opening function of an access control program) is displayed in a program screen of the first program (for example, an order screen for purchasing items); and a check box may be displayed at the periphery (for example, in front) of the prompt information. In a case that the check box is selected, it can be determined that a confirmation input for the prompt information has been received, and in this case, it can be determined that a trigger condition for inspecting the first information is obtained, and in a case that the first information meets a first preset condition (for example, when purchased items are delivered by a courier to a unit door), a door opening function is started.

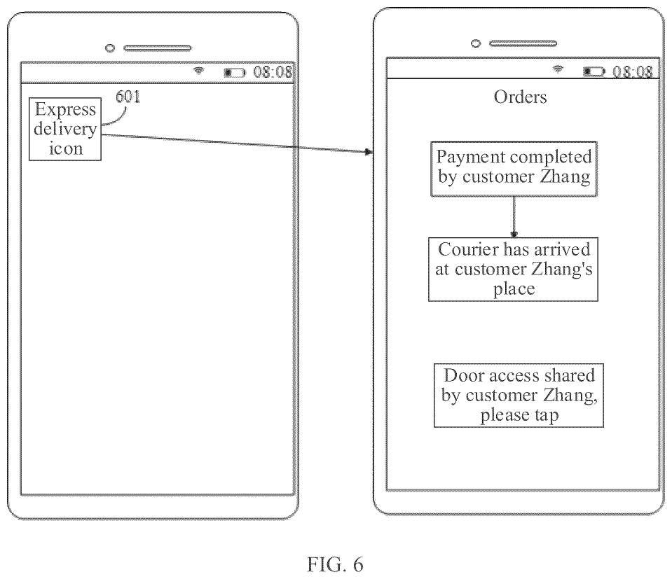

As shown in FIG. 6, a first program is an express package delivery program. According to an input by a courier (in this case, the courier is a user of the first program) for an express delivery icon 601 corresponding to the express package delivery program, an order screen is displayed. The order screen displays dynamic information of goods that customer Zhang has paid for. When the goods are delivered to a designated building unit door, information that customer Zhang has opened the door opening function is displayed and the courier is prompted to click. The courier can start the door opening function to open the unit door after clicking. During synchronizing the door opening function to the first program, customer Zhang can synchronize this function with the courier, so that the courier can open the unit door based on this function. Courier and customer Zhang can communicate based on the first program, so the synchronization of door opening function can be achieved.

In the foregoing implementation process of this application, by displaying the prompt information for the first function in the program screen of the first program, and starting the first function when a confirmation operation by the user to the prompt information is received and the first information meets the first preset condition, it is possible to control the starting of the first function based on the trigger from the user and the trigger of the first information.

In an embodiment of this application, after starting the first function, the method further includes: storing a starting record of the first function.

After the starting of the first function, it is necessary to record the starting of the first function to generate a starting record corresponding to the first function and store the starting record. In storing the starting record, the starting record may be stored in a second storage region corresponding to the second program, in Notepad or Memo, in a first storage region corresponding to the first program that triggered the starting of the first function, or in a communication program associated with the first program or the second program.

With the starting record stored in a second storage region corresponding to the second program, it is possible to know the starting of the first function based on the second storage region; with the starting record stored in Notepad or Memo, it is possible to record the starting of the first function based on Notepad or Memo; with the starting record stored in the first storage region corresponding to the first program, it is possible to know the starting of the first function triggered and started by the first program based on the first storage region; and with the starting record stored in the communication program (that is, sending the starting record to a relevant contact), it is convenient for the user to know the starting of the first function through the communication record.

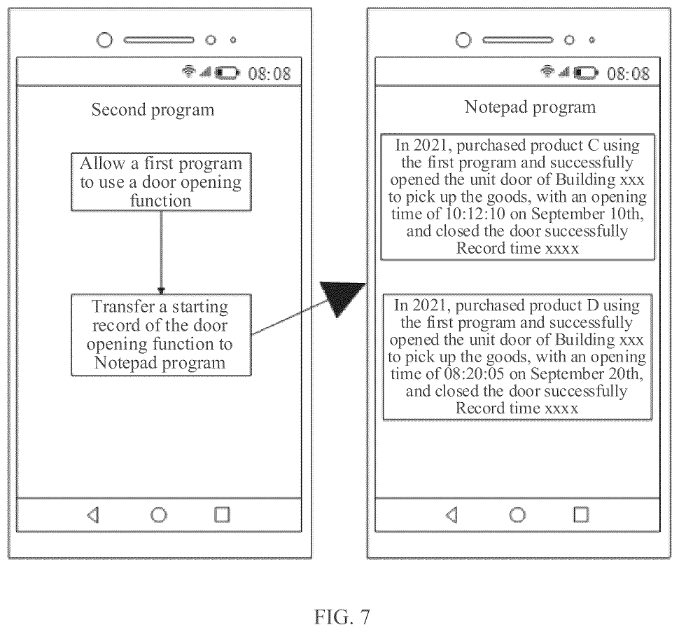

For example, a user purchases goods based on the first program, and when a courier arrives at the unit door, it is determined that the first information from the first program meets the first preset condition, and the door opening function of the second program is started, which is convenient for the courier to deliver in a timely manner. The second program can record the starting of the door opening function and store it in Notepad program, as shown in FIG. 7, so that information about a record of the first program receiving goods based on the door opening function of the second program can be stored in Notepad program.

In the foregoing implementation process of this application, by recording the starting of the first function to facilitate the user to know the starting of the first function through the starting record, and storing the starting record in other programs, it is possible to build communication bridges between different programs and implement data interaction among multiple programs.

In an embodiment of this application, the first program is a first e-commerce program, and the second program is an access control program. The starting a first function in a case that first information meets a first preset condition includes: starting a door opening function of the access control program in a case that delivery information from the first e-commerce program meets the first preset condition.

In this embodiment, the first program is the first e-commerce program, and the second program is the access control program. A user can purchase goods based on the first program and monitor delivery information corresponding to the first e-commerce program when the purchased goods are in delivery. In a case that the delivery information meets the first preset condition, for example, when a deliveryman delivers the goods to a unit door, the first e-commerce program will receive a notification message and determine, based on the notification message, that the delivery information meets the first preset condition, a door opening function of the access control program can be started to control the opening of the unit door so that the deliveryman can enter a corresponding floor for the delivery of the goods.

For starting of the door opening function of the access control program, the door opening function can be directly started by the access control program, or permission can be granted to the first e-commerce program or a target control to call the door opening function, or permission can be granted to the first e-commerce program or the target control to call the door opening function when the access control program directly starts the door opening function.

In the foregoing implementation process of this application, the door opening function of the access control program is started in a case that the delivery information from the first e-commerce program meets the first preset condition, allowing for a smooth delivery of the goods purchased by the user without complicated program switching and simplifying operations by the user while ensuring a timely delivery.

It should be noted that after the first e-commerce program cooperates with the access control program to complete the delivery of goods, a program screen of the access control program can be displayed according to an input by the user, and the program screen of the access control program displays a target region associated with the first e-commerce program. After the program screen of the access control program is displayed, a piece of prompt information prompting that the region is associated with the first e-commerce program can be displayed in the target region, so as to facilitate the user to perform corresponding input in the target region.

The target region is an evaluation region for evaluating the delivery services and/or goods corresponding to the first e-commerce program. Based on an input by the user in the target region, evaluation information for purchased goods and/or delivery services can be obtained. The obtained evaluation information can be synchronized to the first e-commerce program, allowing the user to evaluate the delivery services and/or goods corresponding to the first e-commerce program through the access control program, providing a new way for the user to evaluate the delivery services and/or goods.

In an embodiment of this application, the first program is a second e-commerce program, and the second program is a communication program. The starting a first function in a case that first information meets a first preset condition includes: in a case that shopping information from the second e-commerce program meets the first preset condition, sending target information in the shopping information to at least one contact in the communication program.

In this embodiment, the first program is the second e-commerce program, and the second program is the communication program. Auser can purchase goods based on the second e-commerce program. When shopping information from the second e-commerce program meets the first preset condition, the communication function of the communication program is started, and the target information in the shopping information is sent to a designated contact in the communication program, where the designated contact may be one or more contacts.

For starting of the communication function of the communication program, the communication function can be directly started by the communication program, or permission can be granted to the second e-commerce program or a target control to call the communication function, or permission can be granted to the second e-commerce program or the target control to call the communication function when the communication program directly starts the communication function.

The shopping information from the second e-commerce program meets the first preset condition, which may be that logistics information about the goods purchased through the second e-commerce program meets the first preset condition. For example, after the purchased goods arrive at a storage point, the second e-commerce program will receive a notification message. Based on the notification message, it is determined that the shopping information from the second e-commerce program meets the first preset condition.

When the target information in the shopping information is sent to at least one contact in the communication program, a pickup notification corresponding to the shopping information can be sent to the at least one contact in the communication program. The at least one contact is a pre-designated contact, which can be a contact with a high frequency of communication through the communication program, a contact that is pinned in the communication program, or a communication assistant (for example, a file transfer assistant).

If the user purchases goods for others (for example, friend A), the at least one contact includes friend A. Sending a pickup notification to friend A enables friend A to pick up the goods based on the pickup notification. If the user purchases goods for himself, sending a pickup notification to at least one contact enables the user to obtain the pickup notification based on the communication program without opening the second e-commerce program.

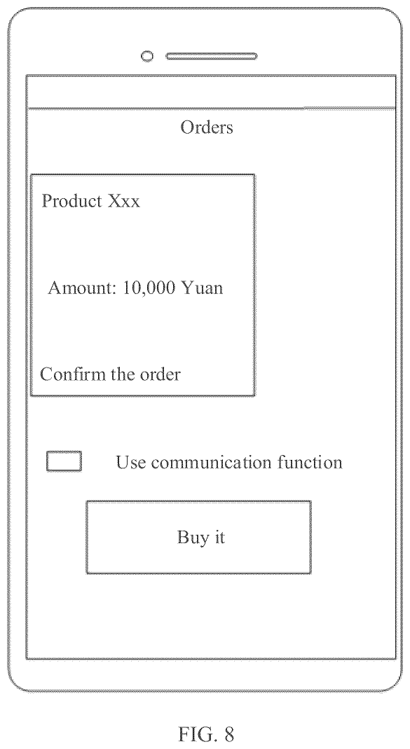

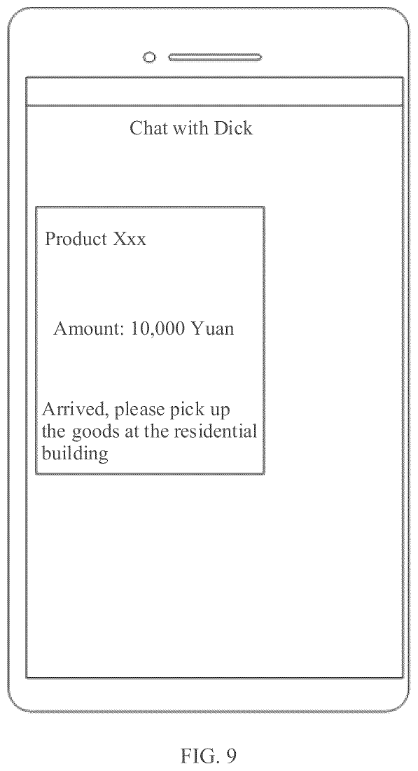

The following describes an implementation of starting a communication function through an example. As shown in FIG. 8, prompt information on whether to use a communication function is displayed in a program screen of the second e-commerce program, and an inspection of the shopping information from the second e-commerce program is triggered when a confirmation input by the user for the prompt information is received. After goods purchased through the second e-commerce program arrive at a storage point, the second e-commerce program will receive a notification message (the notification message is a pickup notification). Based on the notification message, it is determined that shopping information from the second e-commerce program meets the first preset condition. Then the pickup notification is sent to a designated contact. As shown in FIG. 9, a notification message is sent to contact Dick in the communication program, so that the user (Tom) can obtain the pickup notification based on a chat record with Dick.

In the foregoing implementation process of this application, the communication function of the communication program is started in a case that the shopping information from the second e-commerce program meets the first preset condition, allowing target information in the shopping information to be sent to at least one contact in the communication program based on the communication function, so that the user can know the target information based on the communication program.

The foregoing is the overall implementation process of the program control method provided in the embodiments of this application. By displaying the first identifier indicating the first program and the second identifier indicating the second program in the target control, and starting the first function of the second program in a case that the first information from the first program meets the first preset condition, it is possible to implement an association between the first program and the second program based on the target control, trigger the starting of the first function based on the state of the first program, and implement the sharing of the first function, which improves the interaction ability between programs, enriches the capability of information sharing and intercommunication between programs, ensures that the users can effectively cascade programs, reduces the participation frequency of the user in transaction processing, and improves the efficiency of transaction processing.

Further, by granting permission to the target control or the first program to start the first function, it is possible to start the first function based on the indirect calling mode; and by controlling the second program to start the first function, it is possible to start the first function based on direct control. In some alternative embodiments, by granting permission to the target control and controlling the second program to start the first function, or by granting permission to the first program and controlling the second program to start the first function, it is possible to start the first function in two ways, so that when the first function is not started successfully in a way, the first function can be started in a second way.

By displaying the prompt information of the first function on the program screen of the first program, it is possible to control the starting of the first function based on the trigger from the user and the trigger of the first information. By recording the starting of the first function to facilitate the user to know the starting of the first function through the starting record, and storing the starting record in other programs, it is possible to build communication bridges between different programs and implement data interaction among multiple programs, further improving the capability of information sharing between programs and improving the information processing capability of the electronic device.

The door opening function of the access control program is started in a case that the delivery information from the first e-commerce program meets the first preset condition, allowing for a smooth delivery of the goods purchased by the user without complicated program switching and simplifying operations by the user while ensuring a timely delivery. The communication function of the communication program is started in a case that shopping information from the second e-commerce program meets the first preset condition, allowing target information in the shopping information to be sent to at least one contact in the communication program based on the communication function, so that the user can know the target information based on the communication program.

The program control method provided in the embodiments of this application can be executed by a program control apparatus. In the embodiments of this application, a program control apparatus for performing the program control method is used as an example to describe the program control apparatus provided in this embodiment of this application.

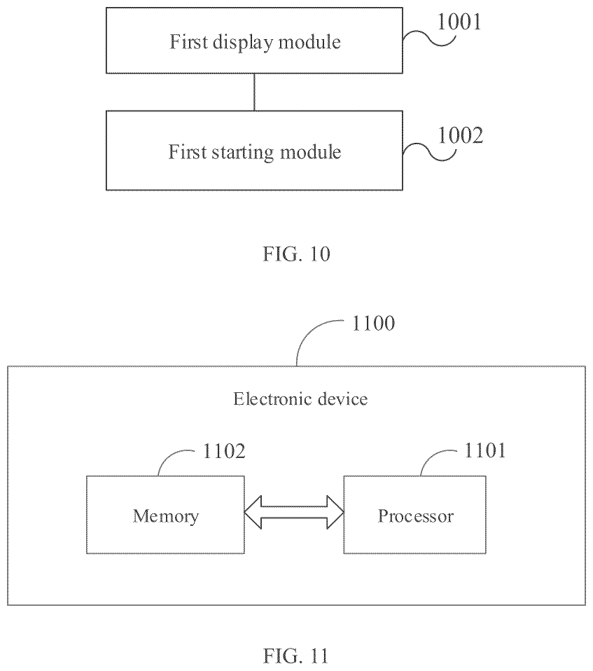

FIG. 10 shows a program control apparatus according to an embodiment of this application. As shown in FIG. 10, the apparatus includes:
a first display module 1001 configured to display a first identifier and a second identifier in a target control, the first identifier being used to indicate a first program and the second identifier being used to indicate a second program; and
a first starting module 1002 configured to start a first function in a case that first information meets a first preset condition; where
the first information is information from the first program, and the first function is a function of the second program.

In some embodiments, the first starting module includes at least one of the following submodules:
a calling submodule configured to grant permission to the target control or the first program to call the first function; and
a control submodule configured to control the second program to start the first function.

In some embodiments, the apparatus further includes:
a prohibiting module configured to, after the calling submodule grants permission to the target control or the first program to call the first function, prohibit the target control or the first program from calling the first function in a case that the first information meets a second preset condition.

In some embodiments, the apparatus further includes:
a first receiving module configured to, before the first display module displays a first identifier and a second identifier in a target control, receive a first input by a user in a case that the target control, a first application icon, and a second application icon are displayed, the first application icon being an icon of the first program and the second application icon being an icon of the second program; and
the first display module is further configured to:
display the first identifier and the second identifier in the target control in response to the first input.

In some embodiments, at least one third identifier is also displayed in the target control, the third identifier being used to indicate a third program. The apparatus further includes:
a second receiving module configured to receive a second input by a user for a first target identifier in the at least one third identifier, the first target identifier being used to indicate a first target program; and
a second starting module configured to, in response to the second input, start the first function in a case that second information meets the first preset condition; where
the second information is information from the first target program.

In some embodiments, the apparatus further includes:
a second display module configured to, before the first starting module starts a first function, display prompt information for the first function in a program screen of the first program; and
the first starting module is further configured to:
start the first function in a case that a confirmation input by the user for the prompt information has been received and that the first information meets the first preset condition.

In some embodiments, the apparatus further includes:
a storage module configured to store a starting record of the first function after the first function is started.

In some embodiments, the first program is a first e-commerce program, and the second program is an access control program. The first starting module is further configured to:
start a door opening function of the access control program in a case that delivery information from the first e-commerce program meets the first preset condition.

In some embodiments, the first program is a second e-commerce program, and the second program is a communication program. The first starting module is further configured to:
in a case that shopping information from the second e-commerce program meets the first preset condition, send target information in the shopping information to at least one contact in the communication program.

The foregoing is an embodiment of the program control apparatus provided in this embodiment of this application. By displaying the first identifier indicating the first program and the second identifier indicating the second program in the target control, and starting the first function of the second program in a case that the first information from the first program meets the first preset condition, it is possible to implement an association between the first program and the second program based on the target control, trigger the starting of the first function based on the state of the first program, and implement the sharing of the first function, which improves the interaction ability between programs, enriches the capability of information sharing and intercommunication between programs, ensures that the users can effectively cascade programs, reduces the participation frequency of the user in transaction processing, improves the efficiency of transaction processing, and optimizes experience of the user in transaction processing.

Further, by granting permission to the target control or the first program to start the first function, it is possible to start the first function based on the indirect calling mode; and by controlling the second program to start the first function, it is possible to start the first function based on direct control. In some alternative embodiments, by granting permission to the target control and controlling the second program to start the first function, or by granting permission to the first program and controlling the second program to start the first function, it is possible to start the first function in two ways, so that when the first function is not started successfully in a way, the first function can be started in a second way.

By displaying the prompt information of the first function on the program screen of the first program, it is possible to control the starting of the first function based on the trigger from the user and the trigger of the first information. By recording the starting of the first function to facilitate the user to know the starting of the first function through the starting record, and storing the starting record in other programs, it is possible to build communication bridges between different programs and implement data interaction among multiple programs, further improving the capability of information sharing between programs and improving the information processing capability of the electronic device.

The door opening function of the access control program is started in a case that the delivery information from the first e-commerce program meets the first preset condition, allowing for a smooth delivery of the goods purchased by the user without complicated program switching and simplifying operations by the user while ensuring a timely delivery. The communication function of the communication program is started in a case that shopping information from the second e-commerce program meets the first preset condition, allowing target information in the shopping information to be sent to at least one contact in the communication program based on the communication function, so that the user can know the target information based on the communication program.

The program control apparatus in this embodiment of this application may be an electronic device, or may be a component in an electronic device such as an integrated circuit or chip. The electronic device may be a terminal or a device other than terminals. For example, the electronic device may be a mobile phone, a tablet computer, a notebook computer, a palmtop computer, a vehicle-mounted electronic device, a Mobile Internet Device (MID), an Augmented Reality (AR)/Virtual Reality (VR) device, a robot, a wearable device, an Ultra-Mobile Personal Computer (UMPC), a netbook, or a Personal Digital Assistant (PDA), or may be a server, a Network Attached Storage (NAS), a Personal Computer (PC), a Television (TV), a teller machine, a self-service machine, or the like. This is not specifically limited in this embodiment of this application.

The program control apparatus in this embodiment of this application may be an apparatus with an operating system. The operating system may be an Android operating system, an Apple mobile device operating system (iPhone Operating System (iOS)), or another possible operating system. This is not specifically limited in this embodiment of this application.

The program control apparatus provided in this embodiment of this application can implement the processes implemented in the embodiment of the program control method in FIG. 1. To avoid repetition, details are not repeated herein.

In some embodiments, as shown in FIG. 11, an embodiment of this application further provides an electronic device 1100, including a processor 1101, a memory 1102, and a program or instructions stored in the memory 1102 and capable of running on the processor 1101, where when the program or instructions are executed by the processor 1101, the processes in the foregoing embodiment of the program control method are implemented, with the same technical effects achieved. To avoid repetition, details are not repeated herein.

It should be noted that the electronic device in an embodiment of this application includes the foregoing mobile electronic device and non-mobile electronic device.

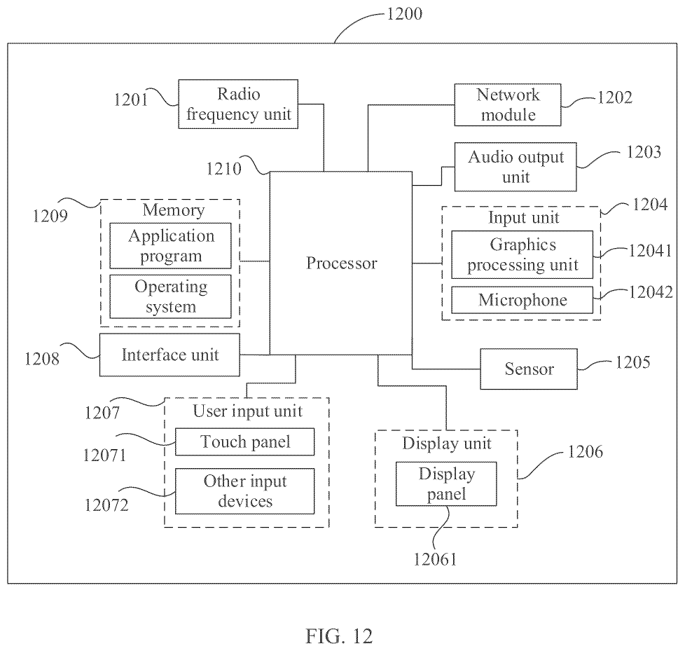

FIG. 12 is a schematic diagram of a hardware structure of an electronic device according to an embodiment of this application.

The electronic device 1200 includes but is not limited to components such as a radio frequency unit 1201, a network module 1202, an audio output unit 1203, an input unit 1204, a sensor 1205, a display unit 1206, a user input unit 1207, an interface unit 1208, a memory 1209, and a processor 1210. The electronic device further includes a plurality of cameras.

Persons skilled in the art can understand that the electronic device 1200 may further include a power supply (for example, a battery) that supplies power to various components. The power supply may be logically connected to the processor 1210 via a power management system, so that functions such as charge and discharge management and power consumption management are implemented via the power management system. The structure of the electronic device shown in FIG. 12 does not constitute a limitation on the electronic device. The electronic device may include more or fewer components than those shown in the figure, or some components may be combined, or there may be a different component layout. Details are not described herein again.

The display unit 1206 is configured to display a first identifier and a second identifier in a target control, the first identifier being used to indicate a first program and the second identifier being used to indicate a second program. The processor 1210 is configured to start a first function in a case that first information meets a first preset condition; where the first information is information from the first program, and the first function is a function of the second program.

In some embodiments, when starting the first function, the processor 1210 further performs at least one of the following steps: granting permission to the target control or the first program to call the first function; and controlling the second program to start the first function.

In some embodiments, after granting permission to the target control or the first program to call the first function, the processor 1210 is further configured to prohibit the target control or the first program from calling the first function in a case that the first information meets a second preset condition.

In some embodiments, before the first identifier and the second identifier are displayed in the target control, the user input unit 1207 is configured to receive a first input by a user in a case that the display unit 1206 displays the target control, a first application icon, and a second application icon, the first application icon being an icon of the first program and the second application icon being an icon of the second program. When the first identifier and the second identifier are displayed in the target control, the display unit 1206 is further configured to display the first identifier and the second identifier in the target control in response to the first input.

In some embodiments, at least one third identifier is also displayed in the target control, the third identifier being used to indicate a third program. The user input unit 1207 is further configured to receive a second input by a user for a first target identifier in the at least one third identifier, the first target identifier being used to indicate a first target program. The processor 1210 is further configured to, in response to the second input, start the first function in a case that second information meets the first preset condition; where the second information is information from the first target program.

In some embodiments, before the starting the first function, the display unit 1206 is further configured to display prompt information for the first function in a program screen of the first program. When the first function is started in a case that first information meets a first preset condition, the processor 1210 is further configured to start the first function in a case that the user input unit 1207 receives a confirmation input by the user for the prompt information and that the first information meets the first preset condition.

In some embodiments, after starting the first function, the processor 1210 is further configured to store a starting record of the first function.

In some embodiments, the first program is a first e-commerce program, and the second program is an access control program. When a first function is started in a case that first information meets a first preset condition, the processor 1210 is further configured to start a door opening function of the access control program in a case that delivery information from the first e-commerce program meets the first preset condition.

In some embodiments, the first program is a second e-commerce program, and the second program is a communication program. When a first function is started in a case that first information meets a first preset condition, the processor 1210 is further configured to, in a case that shopping information from the second e-commerce program meets the first preset condition, send target information in the shopping information to at least one contact in the communication program.

In this way, by displaying the first identifier indicating the first program and the second identifier indicating the second program in the target control, and starting the first function of the second program in a case that the first information from the first program meets the first preset condition, it is possible to implement an association between the first program and the second program based on the target control, trigger the starting of the first function based on the state of the first program, and implement the sharing of the first function. This improves the interaction ability between programs, enriches the capability of information sharing and intercommunication between programs, ensures that the users can effectively cascade programs, reduces the participation frequency of the user in transaction processing, improves the efficiency of the transaction processing, and optimizes experience of the user in transaction processing.

Further, by granting permission to the target control or the first program to start the first function, it is possible to start the first function based on the indirect calling mode; and by controlling the second program to start the first function, it is possible to start the first function based on direct control. In some alternative embodiments, by granting permission to the target control and controlling the second program to start the first function, or by granting permission to the first program and controlling the second program to start the first function, it is possible to start the first function in two ways, so that when the first function is not started successfully in a way, the first function can be started in a second way.

By displaying the prompt information of the first function on the program screen of the first program, it is possible to control the starting of the first function based on the trigger from the user and the trigger of the first information. By recording the starting of the first function to facilitate the user to know the starting of the first function through the starting record, and storing the starting record in other programs, it is possible to build communication bridges between different programs and implement data interaction among multiple programs, further improving the capability of information sharing between programs and improving the information processing capability of the electronic device.

The door opening function of the access control program is started in a case that the delivery information from the first e-commerce program meets the first preset condition, allowing for a smooth delivery of the goods purchased by the user without complicated program switching and simplifying operations by the user while ensuring a timely delivery. The communication function of the communication program is started in a case that shopping information from the second e-commerce program meets the first preset condition, allowing target information in the shopping information to be sent to at least one contact in the communication program based on the communication function, so that the user can know the target information based on the communication program.

It should be understood that in this embodiment of this application, the input unit 1204 may include a Graphics Processing Unit (GPU) 12041 and a microphone 12042. The graphics processing unit 12041 processes image data of still pictures or videos that are obtained by an image capture apparatus (for example, camera) in an image or video capture mode. The display unit 1206 may include a display panel 12061. The display panel 12061 may be configured in a form of a liquid crystal display, an organic light-emitting diode display, or the like. The user input unit 1207 includes at least one of a touch panel 12071 and other input devices 12072. The touch panel 12071 is also referred to as a touchscreen. The touch panel 12071 may include two parts: a touch detection apparatus and a touch controller. The other input devices 12072 may include but are not limited to a physical keyboard, a functional button (such as a volume control button or a power on/off button), a trackball, a mouse, and a joystick. Details are not described herein.

The memory 1209 may be configured to store a software program and various data. The memory 1209 may include a first storage area for storing programs or instructions and a second storage area for storing data. The first storage area may store an operating system, an application program or instructions required by at least one function (for example, a sound playback function or an image playback function), and the like. Additionally, the memory 1209 may be a volatile memory or a non-volatile memory, or the memory 1209 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchronous Link DRAM (SLDRAM), and a Direct Rambus RAM (DRRAM). The memory 1209 in this embodiment of this application includes but is not limited to these and any other suitable types of memories.

The processor 1210 may include one or more processing units. In some embodiments, the processor 1210 may integrate an application processor and a modem processor. The application processor primarily processes operations involving an operating system, user interface, application program, or the like. The modem processor primarily processes radio communication signals, for example, being a baseband processor. It can be understood that the modem processor may be not integrated in the processor 1210.

An embodiment of this application further provides a readable storage medium. The readable storage medium stores a program or instructions, and when the program or instructions are executed by a processor, the processes of the foregoing embodiment of the program control method are implemented, with the same technical effects achieved. To avoid repetition, details are not repeated herein.

The processor is the processor of the electronic device in the foregoing embodiment. The readable storage medium includes a computer-readable storage medium such as a computer ROM, an RAM, a magnetic disk, an optical disc, or the like.

An embodiment of this application further provides a chip. The chip includes a processor and a communication interface, the communication interface is coupled to the processor, and the processor is configured to run a program or instructions to implement the processes of the foregoing embodiment of the program control method, with the same technical effects achieved. To avoid repetition, details are not repeated herein.

It should be understood that the chip mentioned in this embodiment of this application may also be referred to as a system-level chip, a system chip, a chip system, a system-on-chip, or the like.

An embodiment of this application provides a computer program product, where the program product is stored in a storage medium, and the program product is executed by at least one processor to implement the processes of the foregoing embodiment of the program control method, with the same technical effects achieved. To avoid repetition, details are not repeated herein.

It should be noted that in this specification, the terms “include” and “comprise”, or any of their variants are intended to cover a non-exclusive inclusion, so that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. In addition, it should be noted that the scope of the method and apparatus in the implementations of this application is not limited to functions being performed in the order shown or discussed, but may further include functions being performed at substantially the same time or in a reverse order, depending on the functions involved. For example, the described method may be performed in an order different from the order described, and steps may be added, omitted, or combined. In addition, features described with reference to some examples may be combined in other examples.

Persons of ordinary skill in the art may realize that units and algorithm steps of various examples described with reference to the embodiments disclosed in this specification can be implemented by using electronic hardware or a combination of computer software and electronic hardware. Whether the functions are performed by hardware or software depends on particular applications and design constraints of the technical solutions. Persons skilled in the art may use different methods to implement the described functions for each particular application, but it should not be considered that the implementation goes beyond the scope of this disclosure.

It may be clearly understood by persons skilled in the art that, for the purpose of convenient and brief description, for a detailed working process of the foregoing system, apparatus, and unit, reference may be made to a corresponding process in the foregoing method embodiments, and details are not described herein again.

In the embodiments provided in this application, it should be understood that the disclosed apparatus and method may be implemented in other manners. For example, the described apparatus embodiment is merely an example. For example, the unit division is merely logical function division and may be other division in actual implementation. For example, multiple units or components may be combined or integrated into another system, or some features may be ignored or may not be performed. In addition, the displayed or discussed mutual couplings or direct couplings or communication connections may be implemented through some interfaces. The indirect couplings or communication connections between the apparatuses or units may be implemented in electrical, mechanical, or other forms.

The units described as separate parts may or may not be physically separate, and parts displayed as units may or may not be physical units, may be located in one position, or may be distributed on a plurality of network elements. Some or all of the units may be selected based on actual requirements to achieve the objectives of the solutions of the embodiments.

In addition, functional units in the embodiments of this disclosure may be integrated into one processing unit, or each of the units may exist alone physically, or two or more units are integrated into one unit.

Based on the above description of embodiments, persons skilled in the art can clearly understand that the methods in the foregoing embodiments can be implemented through software on a necessary general hardware platform or through hardware only. In some embodiments, the technical solutions of this application entirely, or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, a network device, or the like) to perform the method described in the embodiments of this application.

It can be understood that the embodiments described in the embodiments of this disclosure may be implemented by hardware, software, firmware, middleware, microcode, or a combination thereof. For hardware implementation, a module, a unit, or a subunit may be implemented in one or more Application Specific Integrated Circuits (ASICs), Digital Signal Processors (DSPs), DSP Devices (DSPDs), Programmable Logic Devices (PLDs), Field-Programmable Gate Arrays (FPGAs), general-purpose processors, controllers, microcontrollers, microprocessors, and other electronic units for performing the functions described in this disclosure, or a combination thereof.

For software implementation, the technologies described in the embodiments of the present disclosure may be implemented by modules (such as processes and functions) that perform the functions described in the embodiments of the present disclosure. Software code may be stored in the memory and executed by the processor. The memory may be implemented in or outside the processor.

The foregoing describes the embodiments of this application with reference to the accompanying drawings. However, this application is not limited to the foregoing embodiments. The foregoing embodiments are merely illustrative rather than restrictive. As instructed by this application, persons of ordinary skill in the art may develop many other forms without departing from the principle of this application and the protection scope of the claims, and all such forms fall within the protection scope of this application.

What is claimed is:

1. A program control method, comprising:
displaying a first identifier and a second identifier in a target control, the first identifier being used to indicate a first program and the second identifier being used to indicate a second program; and
starting a first function when first information meets a first preset condition,
wherein the first information is information from the first program, and the first function is a function of the second program.

2. The program control method according to claim 1, wherein starting the first function comprises at least one of the following:
granting permission to the target control or the first program to call the first function; or
controlling the second program to start the first function.

3. The program control method according to claim 2, wherein after granting the permission to the target control or the first program to call the first function, the method further comprises:
prohibiting the target control or the first program from calling the first function when the first information meets a second preset condition.

4. The program control method according to claim 1, wherein before displaying the first identifier and the second identifier in the target control, the method further comprises:
receiving a first input by a user when the target control, a first application icon, and a second application icon are displayed, the first application icon being an icon of the first program and the second application icon being an icon of the second program; and
displaying the first identifier and the second identifier in the target control comprises:
displaying the first identifier and the second identifier in the target control in response to the first input.

5. The program control method according to claim 1, wherein at least one third identifier is further displayed in the target control, the third identifier being used to indicate a third program, and the method further comprises:
receiving a second input by a user for a first target identifier in the at least one third identifier, the first target identifier being used to indicate a first target program; and
in response to the second input, starting the first function when second information meets the first preset condition, wherein
the second information is information from the first target program.

6. The program control method according to claim 1, wherein before starting the first function, the method further comprises:
displaying prompt information for the first function in a program screen of the first program; and
starting the first function when the first information meets the first preset condition comprises:
starting the first function when a confirmation input by the user for the prompt information has been received and that the first information meets the first preset condition.

7. The program control method according to claim 1, wherein after starting the first function, the method further comprises:
storing a starting record of the first function.

8. The program control method according to claim 1, wherein the first program is a first e-commerce program, and the second program is an access control program; and
starting the first function when the first information meets the first preset condition comprises:
starting a door opening function of the access control program when delivery information from the first e-commerce program meets the first preset condition.

9. The program control method according to claim 1, wherein the first program is a second e-commerce program, and the second program is a communication program; and
starting the first function when the first information meets the first preset condition comprises:
when shopping information from the second e-commerce program meets the first preset condition, sending target information in the shopping information to at least one contact in the communication program.

10. An electronic device, comprising: a processor; and a memory having a computer program or an instruction thereon, wherein the program or the instruction, when executed by the processor, causes the processor to perform operations, comprising:
displaying a first identifier and a second identifier in a target control, the first identifier being used to indicate a first program and the second identifier being used to indicate a second program; and
starting a first function when first information meets a first preset condition,
wherein the first information is information from the first program, and the first function is a function of the second program.

11. The electronic device according to claim 10, wherein starting the first function comprises at least one of the following:
granting permission to the target control or the first program to call the first function; or
controlling the second program to start the first function.

12. The electronic device according to claim 11, wherein after granting the permission to the target control or the first program to call the first function, the operations further comprise:
prohibiting the target control or the first program from calling the first function when the first information meets a second preset condition.

13. The electronic device according to claim 10, wherein before displaying the first identifier and the second identifier in the target control, the operations further comprise:
receiving a first input by a user when the target control, a first application icon, and a second application icon are displayed, the first application icon being an icon of the first program and the second application icon being an icon of the second program; and
displaying the first identifier and the second identifier in the target control comprises:
displaying the first identifier and the second identifier in the target control in response to the first input.

14. The electronic device according to claim 10, wherein at least one third identifier is further displayed in the target control, the third identifier being used to indicate a third program, and the operations further comprise:
receiving a second input by a user for a first target identifier in the at least one third identifier, the first target identifier being used to indicate a first target program; and
in response to the second input, starting the first function when second information meets the first preset condition, wherein the second information is information from the first target program.

15. The electronic device according to claim 10, wherein before starting the first function, the operations further comprise:
displaying prompt information for the first function in a program screen of the first program; and
starting the first function when the first information meets the first preset condition comprises:
starting the first function when a confirmation input by the user for the prompt information has been received and that the first information meets the first preset condition.

16. The electronic device according to claim 10, wherein after starting the first function, the operations further comprise:
storing a starting record of the first function.

17. The electronic device according to claim 10, wherein the first program is a first e-commerce program, and the second program is an access control program; and
starting the first function when the first information meets the first preset condition comprises:
starting a door opening function of the access control program when delivery information from the first e-commerce program meets the first preset condition.

18. The electronic device according to claim 10, wherein the first program is a second e-commerce program, and the second program is a communication program; and
starting the first function when the first information meets the first preset condition comprises:
when shopping information from the second e-commerce program meets the first preset condition, sending target information in the shopping information to at least one contact in the communication program.

19. A non-transitory computer-readable storage medium storing instructions that, when executed by a processor, causes the processor to perform operations, comprising:
displaying a first identifier and a second identifier in a target control, the first identifier being used to indicate a first program and the second identifier being used to indicate a second program; and
starting a first function when first information meets a first preset condition,
wherein the first information is information from the first program, and the first function is a function of the second program.

20. The non-transitory computer-readable storage medium according to claim 19, wherein starting the first function comprises at least one of the following:
granting permission to the target control or the first program to call the first function; or
controlling the second program to start the first function.
